(19) United States
(12) Patent Application Publication
(10) Pub. No.: US 2023/0274559 A1
(43) Pub. Date: Aug. 31, 2023

(54) PATTERN SYSTEM

(71) Applicant: StitchList LLC, Atlanta, GA (US)

(72) Inventors: Jesse Babineaux Dillon, Roswell, GA (US); Mauro Velez, Canton, GA (US); Gary Morris Williams, Roswell, GA (US); Marla Johnson Velez, Canton, GA (US)

(73) Assignee: StitchList, LLC, Atlanta, GA (US)

(21) Appl. No.: 17/652,616

(22) Filed: Feb. 25, 2022

(51) Int. Cl. G06V 20/62; G06F 16/583; G06V 10/10; G06F 40/134; G06V 10/25

(52) U.S. Cl. CPC G06V 20/62; G06F 16/5846; G06V 10/16; G06F 40/134; G06V 10/25; G06V 2201/09

(57) ABSTRACT

A method for organizing a pattern comprises receiving an image of a pattern, processing the image to find text in the image, comparing the found text to data in a memory, identifying the data in the memory that corresponds to the found text, and presenting the found data and the data in the memory that corresponds to the found text to a user.

### BACKGROUND

The present invention relates sewing patterns. Sewing patterns are guides that a person uses to perform sewing tasks. Sewing patterns are often printed as lines on paper or another type of sheet product. The patterns may be stored physically or digitally. The paper pattern is used to guide a person through cutting out fabric in the shape of the pattern. In use, the sewing pattern is often laid over or attached to fabric or cloth. The lines on the paper pattern represent the lines that should be cut by a person to form a piece or pieces of fabric that are components of a sown object such as, for example, a garment.

Once the fabric or cloth has been cut using the pattern, the user may connect and finish the sown object by, for example fastening portions of the fabric together by sewing with a machine or by hand. Fasteners may also be used to attach components of the sown object together.

Sewing patterns are available in a large variety of patterns and sizes. These patterns may be used to produce any number of sewn objects or garments.

### SUMMARY

Embodiments are directed to a method for organizing a pattern comprises receiving an image of a pattern, processing the image to find text in the image, comparing the found text to data in a memory, identifying the data in the memory that corresponds to the found text, and presenting the found data and the data in the memory that corresponds to the found text to a user.

A system for organizing a pattern, the system comprises a memory, a processor communicatively connected to the memory, the processor is operative to receive an image of a pattern, process the image to find text in the image, compare the found text to data in a memory, identify the data in the memory that corresponds to the found text, and present the found data and the data in the memory that corresponds to the found text to a user.

A non-transitory computer readable medium that includes instructions that comprise receiving an image of a pattern, processing the image to find text in the image comparing the found text to data in a memory, identifying the data in the memory that corresponds to the found text, and presenting the found data and the data in the memory that corresponds to the found text to a user.

### BRIEF DESCRIPTION OF THE DRAWINGS

FIG. 1 illustrates a block diagram of a system.

FIG. 2 illustrates a block diagram of an exemplary method for operating the system of FIG. 1.

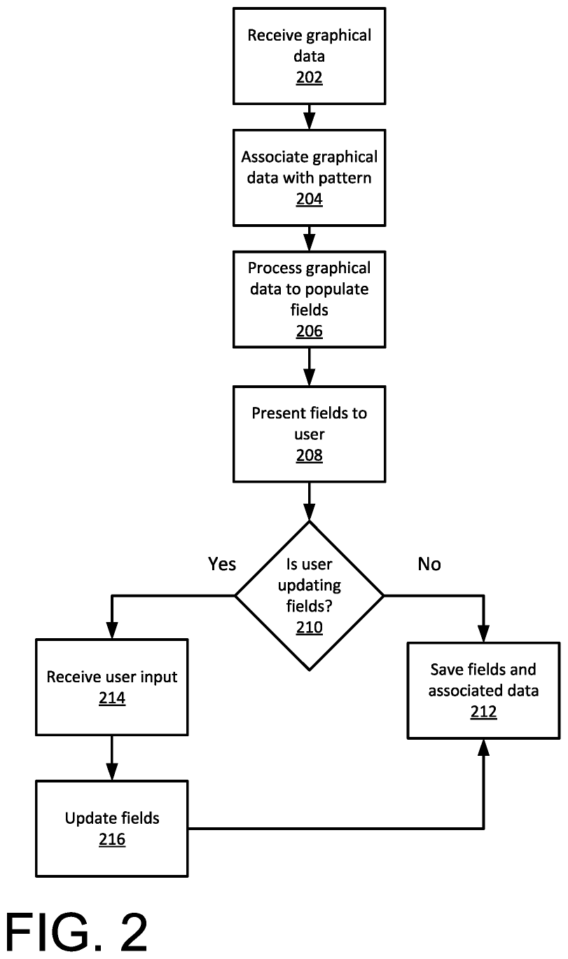

FIG. 3 illustrates a block diagram of another method of operation for the system FIG. 1.

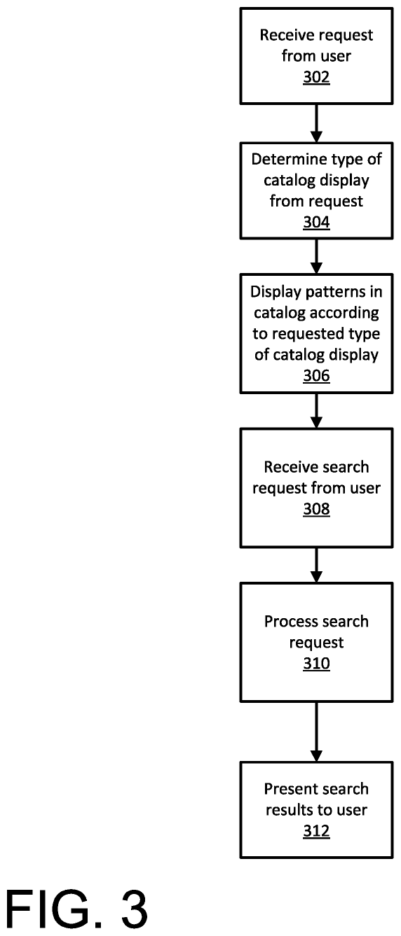

FIG. 4 illustrates a block diagram of a method of operation of the system of FIG. 1.

FIG. 5 illustrates a method of operation of the system of FIG. 1.

FIG. 6 illustrates a sewing pattern.

FIG. 7 illustrates an example of a fabric.

FIG. 8 illustrates an overlay of the pattern of FIG. 6 over the fabric of FIG. 7.

FIG. 9 illustrates embodiments of an overlay of a pattern on a fabric.

FIG. 10 illustrates a block diagram of another example of a method of operation of the system of FIG. 1.

FIG. 11 illustrates a graphical user interface.

### DETAILED DESCRIPTION

Sewing patterns (patterns) include lines that are printed on a sheet product such as, for example, a sheet of paper. The lines represent the pattern for the sizes and shapes of fabric or cloth sheet product components that are used to cut fabric to shape. Once the fabric is cut to shape the fabric may be connected or joined by, for example, sewing by hand or with a machine, adhesives such as tape or glue, or fasteners such as, buttons, or snaps.

Sewing patterns are available commercially and often are sold in packaging such as boxes or envelopes that often include textual or graphical indicators associated with the pattern. For example, a pattern packaging may include a universal product code (UPC) that is unique to the pattern packaging and associated with the pattern. Other indicators may include graphical indicators showing the pattern or an example of a garment or sewn object that may be produced using the pattern. Other textual indicators may include, for example, the name or logo of the brand or manufacture of the pattern, the name of the pattern, the type of sown garment or object and the size of the garment or resultant sewn object.

It is desirable for a system to be operative to receive, store, and catalog sewing patterns to organize and provide for access, sharing and selling of sewing patterns.

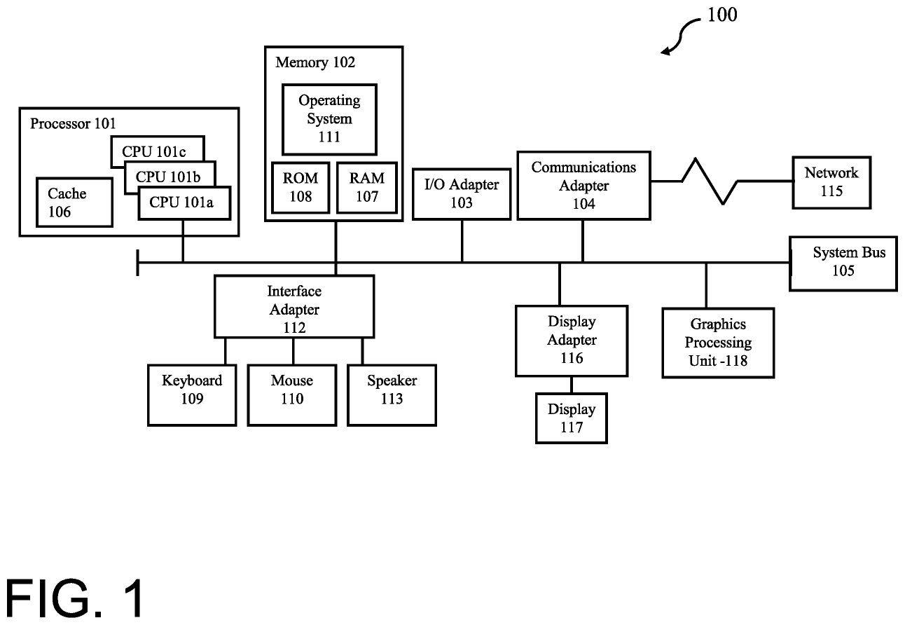

FIG. 1 illustrates a block diagram of an exemplary computing environment and computer system 100 for use in practicing the embodiments described herein. The environment and system described herein can be implemented in hardware, software (e.g., firmware), or a combination thereof. In an exemplary embodiment, a hardware implementation can include a microprocessor of a special or general-purpose digital computer, such as a personal computer, workstation, minicomputer, or mainframe computer. Computer 100 therefore can embody a general-purpose computer. In another exemplary embodiment, the implementation can be part of a mobile device, such as, for example, a mobile phone, a personal data assistant (PDA), a tablet computer, etc.

As shown in FIG. 1, the computer 100 includes processor 101. Computer 100 also includes memory 102 communicatively coupled to processor 101, and one or more input/output adapters 103 that can be communicatively coupled via system bus 105. Memory 102 can be communicatively coupled to one or more internal or external memory devices via a storage interface 108. Communications adapter 116 can communicatively connect computer 100 to one or more networks 106. System bus 105 can communicatively connect one or more user interfaces via input/output (I/O) adapter 103. I/O adapter 103 can connect a plurality of input devices 104 to computer 100. Input devices can include, for example, a keyboard, a mouse, a microphone, a sensor, etc. System bus 105 can also communicatively connect one or more output devices 107 via I/O adapter 103. Output device 107 can include, for example, a display, a speaker, a touchscreen, etc.

Processor 101 is a hardware device for executing program instructions (aka software), stored in a computer-readable memory (e.g., memory 102). Processor 101 can be any custom made or commercially available processor, a central processing unit (CPU), a plurality of CPUs, an auxiliary processor among several other processors associated with the computer 100, a semiconductor-based microprocessor (in the form of a microchip or chip set), or generally any device for executing instructions. Processor 101 can include a cache memory 122, which can include, but is not limited to, an instruction cache to speed up executable instruction fetch, a data cache to speed up data fetch and store, and a translation lookaside buffer (TLB) used to speed up virtual-to-physical address translation for both executable instructions and data. Cache memory 122 can be organized as a hierarchy of more cache levels (L1, L2, etc.).

Processor 101 can be disposed in communication with one or more memory devices (e.g., RAM 109, ROM 110, one or more external databases 121, etc.) via a storage interface 108. Storage interface 108 can also connect to one or more memory devices including, without limitation, one or more databases 121, and/or one or more other memory drives (not shown) including, for example, a removable disc drive, etc., employing connection protocols such as serial advanced technology attachment (SATA), integrated drive electronics (IDE), IEEE-1394, universal serial bus (USB), fiber channel, small computer systems interface (SCSI), etc. The memory drives can be, for example, a drum, a magnetic disc drive, a magneto-optical drive, an optical drive, a redundant array of independent discs (RAID), a solid-state memory device, a solid-state drive, etc. Variations of memory devices can be used for implementing, for example, list all databases from other figures.

Memory 102 can include random access memory (RAM) 109 and read only memory (ROM) 110. RAM 109 can be any one or combination of volatile memory elements (e.g., DRAM, SRAM, SDRAM, etc.). ROM 110 can include any one or more nonvolatile memory elements (e.g., erasable programmable read only memory (EPROM), flash memory, electronically erasable programmable read only memory (EEPROM), programmable read only memory (PROM), tape, compact disc read only memory (CD-ROM), disk, cartridge, cassette or the like, etc.). Moreover, memory 102 can incorporate electronic, magnetic, optical, and/or other types of non-transitory computer-readable storage media. Memory 102 can also be a distributed architecture, where various components are situated remote from one another, but can be accessed by processor 101.

The instructions in memory 102 can include one or more separate programs, each of which can include an ordered listing of computer-executable instructions for implementing logical functions. In the example of FIG. 1, the instructions in memory 102 can include an operating system 111. Operating system 111 can control the execution of other computer programs and provides scheduling, input-output control, file and data management, memory management, and communication control and related services.

The program instructions stored in memory 102 can further include application data 112, and for a user interface 113.

Memory can also include program instructions for Engine 1, configured to improve the wellness of a user.

I/O adapter 103 can be, for example but not limited to, one or more buses or other wired or wireless connections. I/O adapter 103 can have additional elements (which are omitted for simplicity) such as controllers, microprocessors, buffers (caches), drivers, repeaters, and receivers, which can work in concert to enable communications. Further, I/O adapter 103 can facilitate address, control, and/or data connections to enable appropriate communications among the aforementioned components.

I/O adapter 103 can further include a display adapter coupled to one or more displays. I/O adapter 103 can be configured to operatively connect one or more input/output (I/O) devices 107 to computer 100. For example, I/O 103 can connect a keyboard and mouse, a touchscreen, a speaker, a haptic output device, or other output device. Output devices 107 can include but are not limited to a printer, a scanner, and/or the like. Other output devices can also be included, although not shown. Finally, the I/O devices connectable to I/O adapter 103 can further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like.

According to some embodiments, computer 100 can include a mobile communications adapter 123. Mobile communications adapter 123 can include GPS, cellular, mobile, and/or other communications protocols for wireless communication.

In some embodiments, computer 100 can further include communications adapter 116 for coupling to a network 106.

Network 106 can be an IP-based network for communication between computer 100 and any external device. Network 106 transmits and receives data between computer 100 and devices and/or systems external to computer 100. In an exemplary embodiment, network 106 can be a managed IP network administered by a service provider. Network 106 can be a network internal to an aircraft, such as, for example, an avionics network, etc. Network 106 can be implemented in a wireless fashion, e.g., using wireless protocols and technologies, such as Wi-Fi, WiMAX, etc. Network 106 can also be a wired network, e.g., an Ethernet network, an ARINC 429 network, a controller area network (CAN), etc., having any wired connectivity including, e.g., an RS232 connection, R5422 connection, etc. Network 106 can also be a packet-switched network such as a local area network, wide area network, metropolitan area network, Internet network, or other similar type of network environment. The network 106 can be a fixed wireless network, a wireless local area network (LAN), a wireless wide area network (WAN) a personal area network (PAN), a virtual private network (VPN), intranet or other suitable network system.

Network 106 can operatively connect computer 100 to one or more devices including device 117, device 118, and device 120. Network 106 can also connect computer 100 to one or more servers such as, for example, server 119.

If computer 100 is a PC, workstation, laptop, tablet computer and/or the like, the instructions in the memory 102 can further include a basic input output system (BIOS) (omitted for simplicity). The BIOS is a set of routines that initialize and test hardware at startup, start operating system 111, and support the transfer of data among the operatively connected hardware devices. The BIOS is typically stored in ROM 110 so that the BIOS can be executed when computer 100 is activated. When computer 100 is in operation, processor 101 can be configured to execute instructions stored within the memory 102, to communicate data to and from the memory 102, and to generally control operations of the computer 100 pursuant to the instructions.

As discussed above, a system for receiving and cataloging sewing patterns is desirable. In this regard, In block 202, graphical data is received. The graphical data may include, for example, an image of a pattern or packaging for the pattern that may include information associated with the pattern. The information or data may include, for example, a name of the pattern manufacturer, a universal product code (UPC) a part number, a name of the pattern, size of the pattern, and other data such as, for example, whether the pattern is intended for men's, women's, or children's clothing.

In block 204, the graphical data is associated with a pattern in block 204. In block 206, the graphical data is processed by the system 100 (of FIG. 1) to populate fields in memory or a database communicatively connected in the system 100. Once the fields are populated, in block 208, the fields are presented to the user. The user is given an option to update the fields in block 210. If the user does not desire to update the fields in block 212, the fields and associated data are saved in memory.

In embodiments, the graphical data collected as discussed above, may be used to identify a pattern. Once the pattern is identified or the user enters a name of the pattern, the models may be searched to determine if a model matching the user input in block 214 is present in the system 100. If so, the user may be presented with an option to update fields in block 216.

If the user desires to update fields, in block 216, the system 100 receives user input. The user input may include, for example, a physical location of the pattern, a description of how challenging the pattern is to use, whether the pattern has been cut or trimmed. Whether the user has used to pattern to fabricate an object such as, for example, clothing or other sown objects. The other fields may include notes about the pattern and images of objects fabricated using the pattern. Photos of a sewing project, an edited pattern, or additional patterns may also be added. Once the fields are updated, the fields and associated data are saved in block 212. The data in the fields as well as other information associated with the pattern may be saved as a model. Thus, a plurality of models form a catalog of patterns.

In this regard, the system 100 is operative to present cataloged or saved fields associated with a pattern or patterns to a user.

In block 302 a request is received from a user, the request may include, for example, a request to view patterns or identifiers of patterns that correspond to or are associated with pattern data saved in the system 100. The request may include a request to view patterns (or data associated with patterns) by, for example a hierarchy of categories of patterns, a types of patterns (e.g., garment type), or descriptive tags associated with a pattern or patterns in block 304.

The hierarchies may be used to display patterns in the catalog according to the requested display type in block 306. In block 308 a search request is received from the user. In this regard, the user may enter a search request by selecting one of the hierarchy of categories or a particular pattern if desired. In block 310 the system 100 (of FIG. 1) processes the search request to identify cataloged patterns that correspond to the search request.

In block 312, the search results are presented to the user. The user in block 312 may view the results that includes models that correspond to the search criteria of the user.

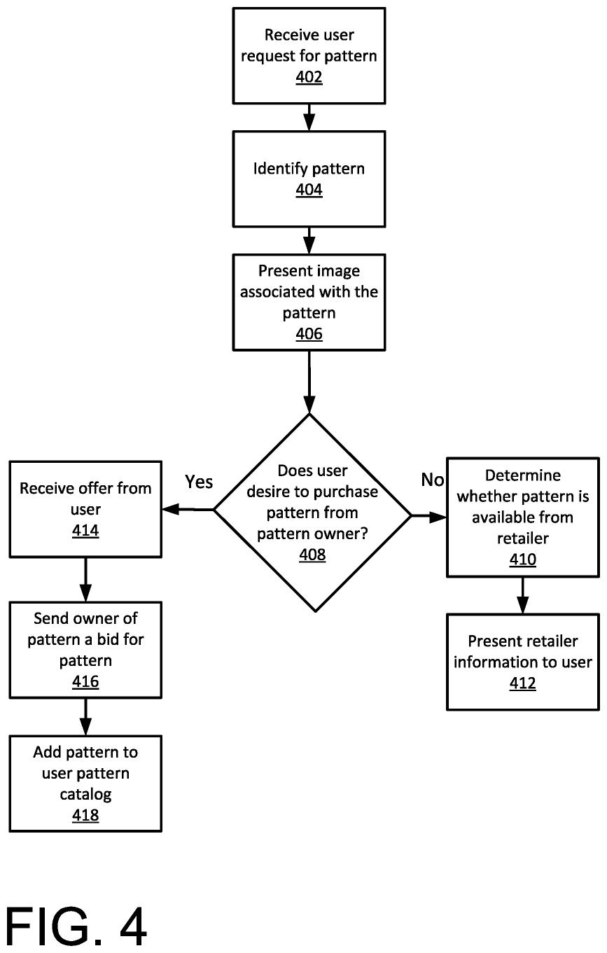

In embodiments, the system 100 (of FIG. 1) may be further operative to provide a sharing or purchasing for users. FIG. 4 illustrates a block diagram of a method of operation of the system of FIG. 1. Referring to FIG. 4, the system 100 receives a user request for a pattern in block 402. In block 404, the pattern is identified. The pattern may be identified by, for example a search performed by the user that may include graphical images or textual indicators. Such a search may identify models relevant to the search.

In embodiments, in block 406 an image of the pattern may be presented to the user. The image may include the actual pattern or in embodiments, images of the packaging of the pattern, or other graphical or textual descriptions of the pattern.

In block 408 the system 100 receives an input from user indicating whether the user desires to purchase a pattern from a pattern owner. If no, the system 100 determines in block 410 whether the pattern is available from a retailer. In block 412, information associated with a retailer (e.g., a retail website) is presented to the user.

If yes in block 408, the system 100 receives an offer for the desired pattern from the user in block 414. The offer may include monetary, points or tokens, and trades among other forms of payment. In block 416, the bid is sent to the owner of the pattern the bid for the pattern. The pattern is added to the user pattern catalog of the saved models. In block 418, the pattern is added to a pattern catalog associated with the user.

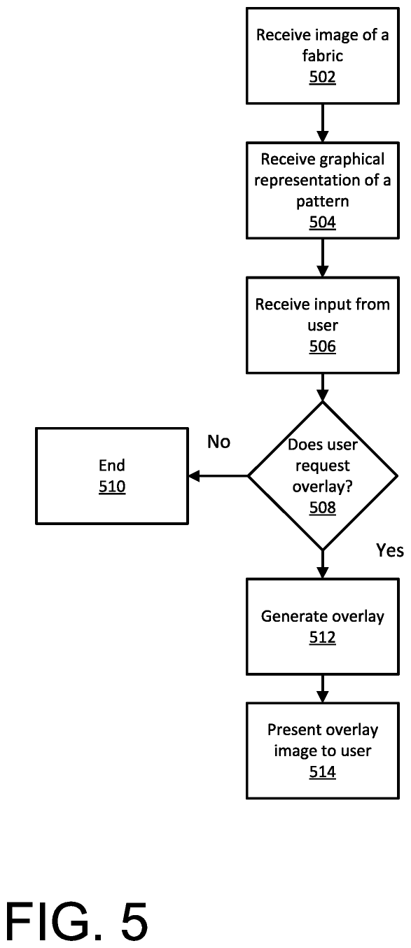

FIG. 5 illustrates a method of operation of the system 100 (of FIG. 1). The method includes graphically depicting fabric that may be overlayed with a pattern. This depiction may assist a user in visualizing or understanding the pattern and how the pattern will look once the fabric has been cut.

In block 502, an image is received of a pattern. The image may include, for example a photographic image of the fabric or any other visual or visible representation of a fabric such as, for example, graphical representations of texture, color, or graphical pattern.

In block 504, a graphical representation of the pattern is received or generated. The image or graphical representation of the pattern may include, for example, textual or graphical indicators such as words or other text, solid or dashed lines, instructions, or any other representation of the pattern. Input is received from the user in block 506 that indicates whether the user has requested an overlay of the pattern on the fabric. If no, the method may end in block 510. If yes, the overlay of the pattern on the fabric is generated in block 512. The overlay image is presented to the user in block 514.

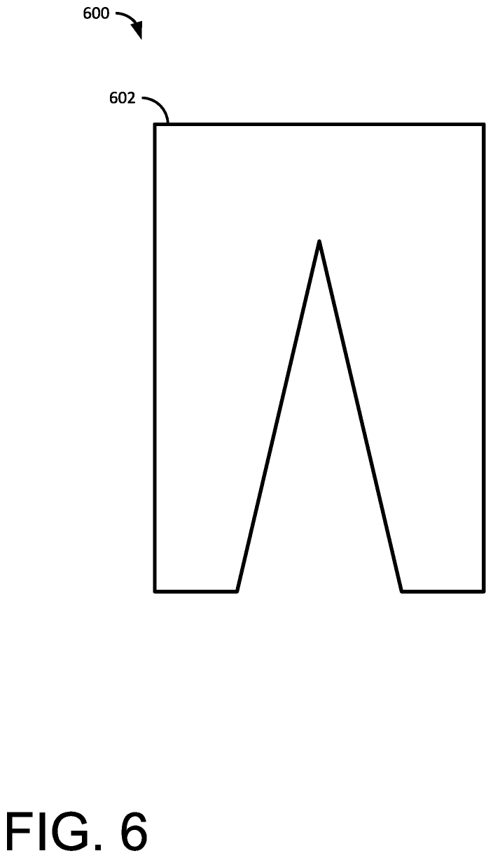

FIG. 6 illustrates a sewing pattern (pattern) 600. The sewing pattern has lines 602, which in this example, includes a pattern for a panel (or component) of trousers. In embodiments, the pattern 600 may be represented by lines and numbers arranged on a sheet of paper or another sheet product.

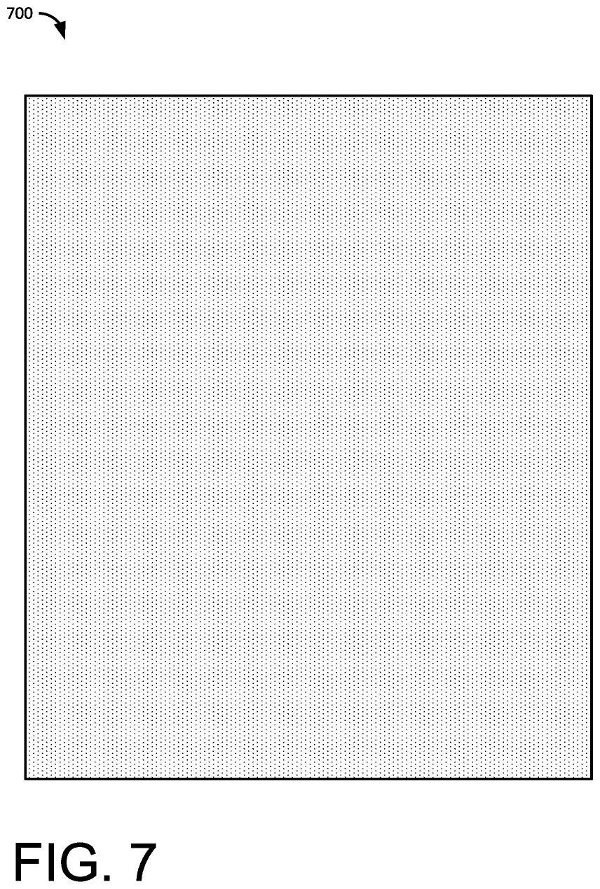

FIG. 7 illustrates an example of a fabric 700. The fabric may include, for example, any type of woven or non-woven sheet product.

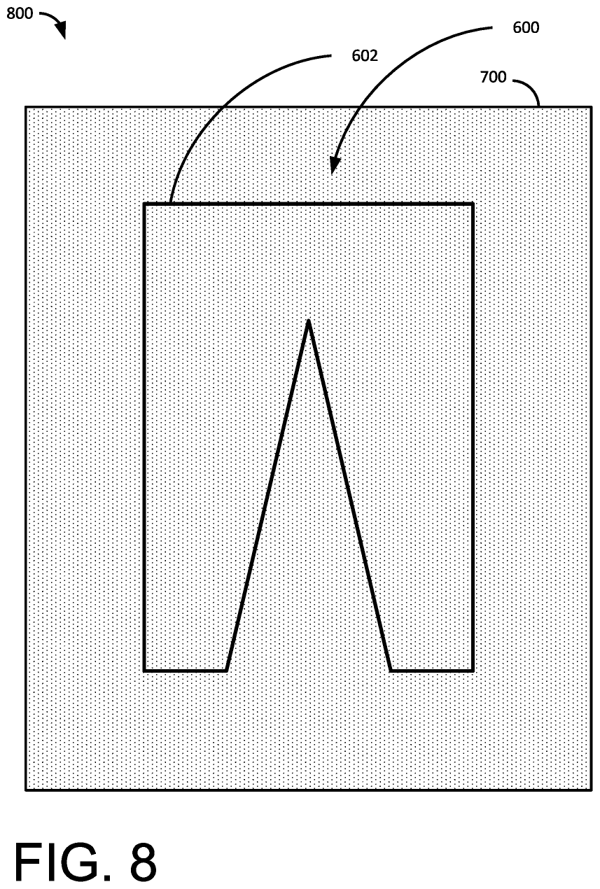

FIG. 8 illustrates an overlay 800 of the pattern 600 (of FIG. 6) over the fabric 700 (of FIG. 7). The lines 602 of the pattern 600 are arranged on the fabric 700. Such an overlay allows a user to view a visual representation of the pattern lines 602 on the fabric 700 that looks like a user actually placing or overlaying the pattern 600 on a fabric. Such an overlay allows the user to see an image of a particular type or color of the fabric with the pattern overlay. The user may also use the overlay presented to the user to determine how much fabric should be used with the pattern. In embodiments the user may use the overlay to determine the difficulty or time needed to complete the garment or object.

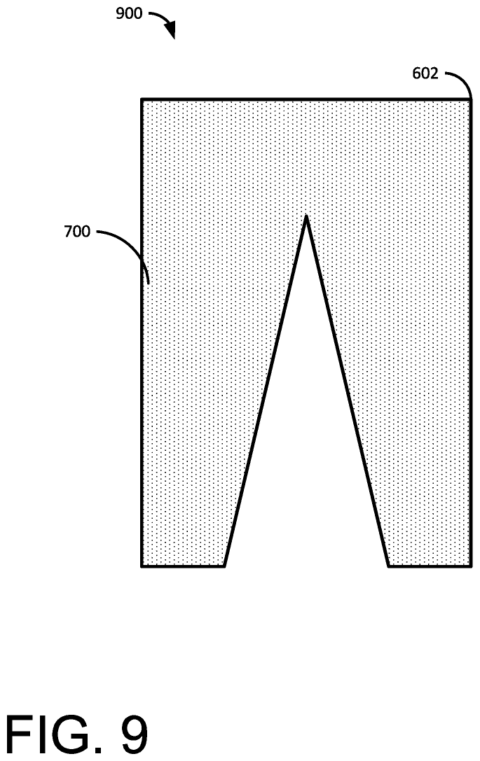

FIG. 9 illustrates embodiments of an overlay of a pattern on a fabric 700. In this regard, the pattern 602 has been used to define a portion 900 of the trouser garment, the fabric 700 arranged outside of the pattern 602 has been removed. Such a representation of the overlay provides the user with an image of the panel or portion of the garment as if the portion has been removed from the original portion of the fabric 700 (in FIG. 7).

In embodiments, the models or patterns associated with models may be grouped for to organize and coordinate a project. Such a project, such as, for example, a sewing project may include one or more users. The project may operate to track and administer a collaborative effort from multiple users. Such administration may include providing patterns, fabrics, or other supplies associated with the project to the users. For example, the system 100 (of FIG. 1) may present the patterns associated with a project to the users. The users may select the patterns that the user desires to use to make a portion of the project. The number of portions associated with each pattern for the project may indicate how many components of a pattern should be made to complete the project. Thus, when the users may indicate that they have finished a particular component of the project and how many similar components the user has completed. Such a method provides a group of users with a portal to collaborate to complete projects.

In embodiments, users may be awarded points for performing actions such as, for example, uploading patterns, creating projects or completing patterns and projects. Other points or badges may be awarded to a user when the user buys or sells a pattern to another user or for participating in a user forum.

A pattern may be added to the catalog library when a pattern is purchased or following a purchase.

In embodiments, the system 100 (of FIG. 1) may include a catalog of fabrics 700 (of FIG. 7) that may be entered by a user. The catalog of fabrics may be used to generate overlays as discussed above. The catalog of fabrics may also include, for example, a description of the fabric, a manufacturer of the fabric, a cost of the fabric, and retail outlets that carry the fabric for retail sale. A fabric may be associated with a pattern when desired such that a user may view patterns or fabrics that are linked to each other.

Patterns may be rated by users to allow other users to benefit from an opinion of a user who has experience with a particular pattern or patterns.

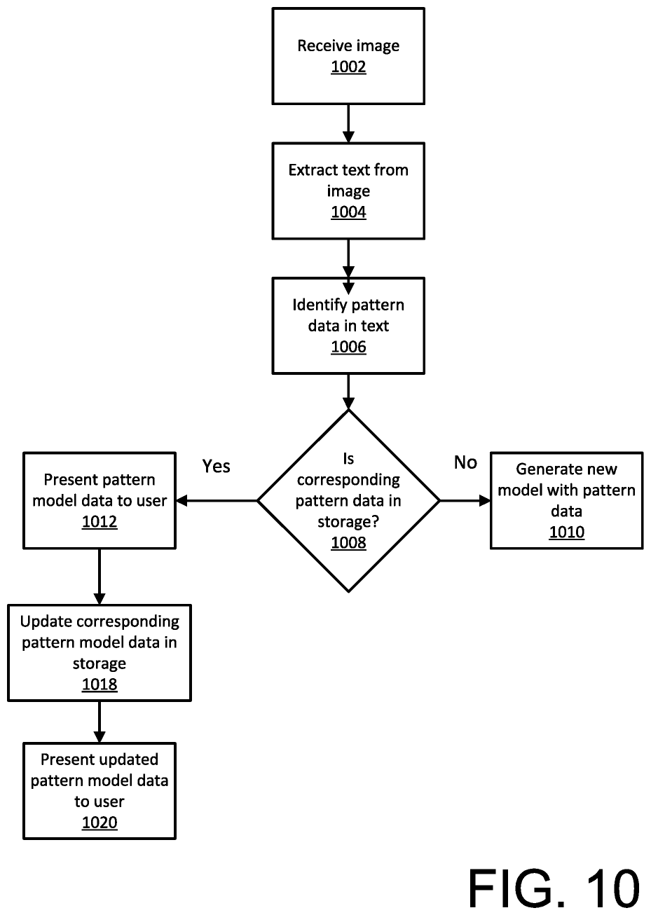

FIG. 10 illustrates a block diagram of another example of a method of operation of the system 100 (of FIG. 1). In this regard, the system 100 receives an image in block 1002. The image may include, for example, an image of the packaging or a portion of the packaging of a pattern, or an image of a particular pattern or portions of a pattern. The received image may be associated with descriptors such as, for example, the format of the pattern, the type of file (e.g., PDF). The system 100 thus, receives image and other files such, as for example, PDF files and stores the files, the format of the associated files, and other data such as a UPC code associated with the files.

In block 1004 text from the image file is extracted. The text may be, for example, broken into individual words and phrases, each series of text may be arranged in a continuous or semicontinuous string. Logos in the image may be annotated and ordered by a confidence in accuracy score. The extracted text may be arranged in tables, rows or cells. Text may be arranged in individual words or phrases. A list of products associated with a UPC in the image may be used to identify retailers that carry the pattern associated with the image or provide other information about the pattern associated with the image.

In block 1006, the pattern associated with the image is determined by identifying the categories, manufacturer, number and sizes of the pattern.

In block 1008, the system 100 (of FIG. 1) determines if a corresponding pattern data is available in the memory of the system 100. In this regard, the models in the system 100 may be searched to find a model (a record in storage) or models that match the image by, for example, using the extracted text from the image file to match with a model in the storage of the system 1000.

The matches may be facilitated by, for example, assigning a matching score to for the model and the data extracted from the image. Thus, a greater score may be assigned when the extracted data and a model are compared if the match is good (e.g., 85% confident). Lower scores may be assigned when the match is less accurate.

A manufacture of a pattern associated with the data from the image may be determined by, for example, searching for words and synonyms for the manufacturer. A logo may be identified and matched with a logo of a manufacturer. If the match is good, a higher point value may be assigned to the match. In embodiments, a substantial amount of the extracted text may be used to search for manufacturer information or identification.

In embodiments, the pattern may be associated with a category. The categories are arranged in a hierarchy such that categories may have children and the children may have children. In operation, the system 100 (of FIG. 1) recursively iterates the categories and synonyms for the categories. Words and phrases may be compared to the manufacturer name and stored synonyms. If the match score is above a threshold, the search points are added to the identified manufactured. If the match substantially above the threshold, the system 100 may continue to search children of the category. Using the text data extracted from the image, the amount of matches may be determined.

A size of the pattern associated with the image and text data extracted from the image may be determined. Phrases indicating a particular size (e.g., small, medium, large) may be searched for to determine a size of the pattern.

As discussed above, a table may be generated. Results may be iterated and organized by page. Phrases that use keywords such as, for example, “size chart” may be marked as a “potential title”. The tables that are on a page following a potential title may be marked as a “potential size chart”. The result is scored for strength by calculating strength as a function of the first column cells and the corresponding column headers. If, for example, a first column header indicates a unit of measure, or indicates a body measurement, the table is considered or identified as a “size chart”.

If a UPC code is found in the image, a search for the UPC code may be used to identify associated data and add the data to search results.

Referring to FIG. 10, block 1008, if the corresponding pattern data is not in storage, a new model with pattern data may be generated in block 1010. If yes in block 1008, the pattern model data may be presented to a user (as discussed in further detail below) in block 1012. In block 1018 the data extracted from the image may be used to update the stored model if the image data has additional data or corrected data for storage in the model.

In block 1020, the updated pattern model data may be displayed to the user.

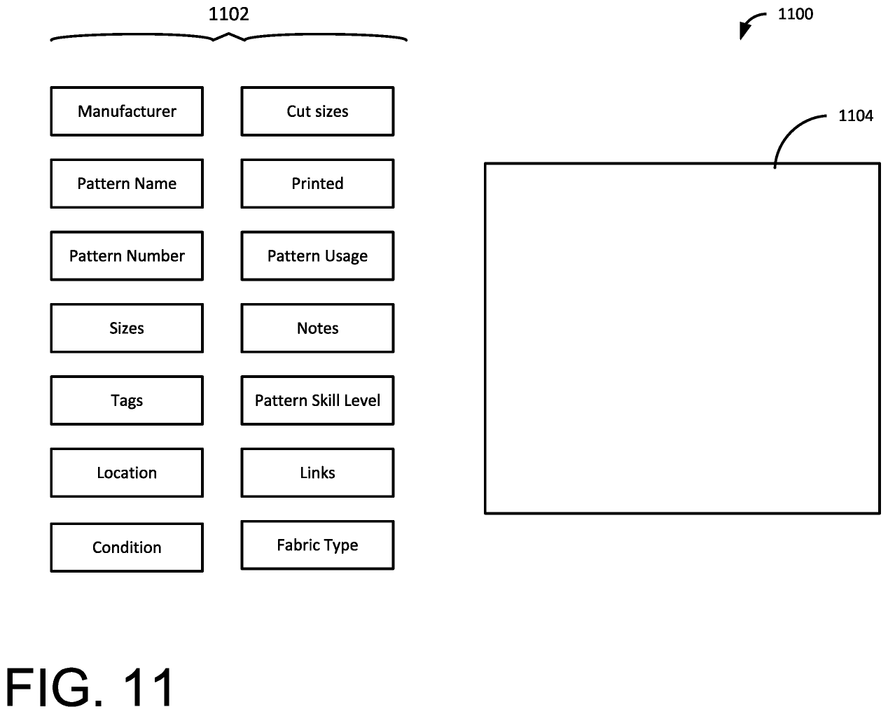

In this regard, FIG. 11 illustrates a graphical user interface 1100. In embodiments, the interface 1100 may include any number of field entry and display boxes 1102. The interface 1100 may include a window 1104. The window 1104 may display, for example, images of a sewing pattern or packaging of the pattern. The window 1104 may also show the sewing pattern and fabric overlayed as discussed above.

The field entry boxes 1102 shown in FIG. 11 are merely examples and may include any number of fields or field entries. In embodiments the boxes 1102 include a manufacturer field, a pattern name field that may include a pattern name, a pattern number that is associated with the pattern, sizes of the pattern and tags associated with the pattern. The boxes 1102 may also include a location of the pattern, e.g., a storage location, a condition of the pattern, cut sizes for the pattern, whether the pattern should be printed from a digital file, the usage of the pattern, e.g., has the pattern been used. Notes associated with the pattern may be entered in the boxes 1102. The boxes 1102 may also include entries for a pattern skill level, hyperlinks associated with the pattern and information about fabric associated with the pattern.

The system 100 described above to provide a user with an opportunity to store and manage data that is associated with sewing patterns. The system may store data associated with sewing patterns in a user-friendly format to allow the user to access records associated with a swing pattern. The system may provide a user with a marketplace to sell or exchange sewing patterns as well as organize collaborative projects.

The present invention can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for organizing a pattern, the method comprising:
receiving an image of a pattern;
processing the image to find text in the image;
comparing the found text to data in a memory;
identifying the data in the memory that corresponds to the found text; and
presenting the found data and the data in the memory that corresponds to the found text to a user.

2. The method of claim 1, wherein the pattern includes a sewing pattern.

3. The method of claim 1, wherein the processing the image includes identifying a logo in the image.

4. The method of claim 1, wherein the presenting the found data includes:
presenting an image of the pattern to the user;
presenting an image of a fabric to the user; and
overlaying the image of the pattern on the image of the fabric and presenting the overlayed image of the pattern on the image of the fabric to the user.

5. The method of claim 1, wherein the presenting the found data and the data in the memory that corresponds to the found text to the user includes presenting a hyperlink to a website that includes data associated with the pattern.

6. The method of claim 1, wherein the data in the memory includes a manufacturer associated with the pattern, a name associated with the pattern, a number associated with the pattern and a size associated with the pattern.

7. The method of claim 1, further comprising presenting a fabric associated with the pattern to the user.

8. A system for organizing a pattern, the system comprising:
a memory; and
a processor communicatively connected to the memory, the processor is operative to:
receive an image of a pattern;
process the image to find text in the image;
compare the found text to data in a memory;
identify the data in the memory that corresponds to the found text; and
present the found data and the data in the memory that corresponds to the found text to a user.

9. The system of claim 8, wherein the pattern includes a sewing pattern.

10. The system of claim 8, wherein the processing the image includes identifying a logo in the image.

11. The system of claim 8, wherein the presenting the found data includes:
presenting an image of the pattern to the user;
presenting an image of a fabric to the user; and
overlaying the image of the pattern on the image of the fabric and presenting the overlayed image of the pattern on the image of the fabric to the user.

12. The system of claim 8, wherein the presenting the found data and the data in the memory that corresponds to the found text to the user includes presenting a hyperlink to a website that includes data associated with the pattern.

13. The system of claim 8, wherein the data in the memory includes a manufacturer associated with the pattern, a name associated with the pattern, a number associated with the pattern and a size associated with the pattern.

14. The system of claim 8, wherein the processor is further operative to present a fabric associated with the pattern to the user.

15. A non-transitory computer readable medium that includes instructions comprising:
receiving an image of a pattern;
processing the image to find text in the image;
comparing the found text to data in a memory;
identifying the data in the memory that corresponds to the found text; and
presenting the found data and the data in the memory that corresponds to the found text to a user.

16. The computer readable medium of claim 15, wherein the pattern includes a sewing pattern.

17. The computer readable medium of claim 15, wherein the processing the image includes identifying a logo in the image.

18. The computer readable medium of claim 15, wherein the presenting the found data includes:
presenting an image of the pattern to the user;
presenting an image of a fabric to the user; and
overlaying the image of the pattern on the image of the fabric and presenting the overlayed image of the pattern on the image of the fabric to the user.

19. The computer readable medium of claim 15, wherein the presenting the found data and the data in the memory that corresponds to the found text to the user includes presenting a hyperlink to a website that includes data associated with the pattern.

20. The computer readable medium of claim 15, wherein the data in the memory includes a manufacturer associated with the pattern, a name associated with the pattern, a number associated with the pattern and a size associated with the pattern.
